(19) United States
(12) Patent Application Publication
(10) Pub. No.: US 2026/0122114 A1
(43) Pub. Date: Apr. 30, 2026

(54) DYNAMIC SELECTION OF PROXY CALL SESSION CONTROL FUNCTION IN TELECOMMUNICATIONS NETWORKS

(71) Applicant: DISH Wireless L.L.C., Englewood, CO (US)

(72) Inventors: Krupal Kumar Patel, Parker, CO (US); Partha Tripathy, Highland Ranch, CO (US); Sruthi Nair, Aurora, CO (US); Mohammad Dawood Shahdad, Aurora, CO (US); Prakash Patel, Castle Rock, CO (US); Myolla D’Costa, Littleton, CO (US)

(21) Appl. No.: 18/926,138

(22) Filed: Oct. 24, 2024

(51) Int. Cl. H04L 65/1073; H04L 65/1016; H04L 65/1045

(52) U.S. Cl. CPC H04L 65/1073; H04L 65/1016; H04L 65/1045

(57) ABSTRACT

Systems and methods of selecting a proxy call session control function (P-CSCF) perform or comprise receiving a registration request at a first network node of the telecommunication network, the registration request including a request from a user equipment (UE) to establish an Internet Protocol (IP) Multimedia Subsystem (IMS) connection; for each P-CSCF of a plurality of candidate P-CSCFs, resolving a health status; and transmitting at least one P-CSCF IP address to the UE based on the resolved health statuses of the plurality of candidate P-CSCFs.

### BACKGROUND

This disclosure relates to wireless data networks, such as 5G wireless networks. Wireless networks that transport digital data and telephone calls are becoming increasingly sophisticated. Currently, fifth generation (5G) broadband cellular networks are being deployed around the world. These 5G networks use emerging technologies to support data and voice communications with millions, if not billions, of mobile phones, computers, and other devices. 5G technologies are capable of supplying much greater bandwidths than previously available technologies.

The discussion above is merely provided for general background information and is not intended to be used as an aid in determining the scope of the claimed subject matter.

### SUMMARY

Various aspects of the present disclosure relate to systems and methods in a telecommunications network to provide dynamic selection of session functions.

According to one aspect of the present disclosure, a method of performing proxy call session control function (P-CSCF) selection in a telecommunications network is provided. The method comprises receiving a registration request at a first network node of the telecommunication network, the registration request including a request from a user equipment (UE) to establish an Internet Protocol (IP) Multimedia Subsystem (IMS) connection; for each P-CSCF of a plurality of candidate P-CSCFs, resolving a health status; and transmitting at least one P-CSCF IP address to the UE based on the resolved health statuses of the plurality of candidate P-CSCFs.

According to another aspect of the present disclosure, a telecommunications network is provided. The network comprises at least one first processor in communication with a first network node of the telecommunications network; and a first memory storing first instructions that, when executed by the at least one first processor, cause the first network node to: receive a registration request at a first network node of the telecommunication network, the registration request including a request from a user equipment (UE) to establish an Internet Protocol (IP) Multimedia Subsystem (IMS) connection, for each P-CSCF of a plurality of candidate P-CSCFs, resolve a health status, and transmit at least one P-CSCF IP address to the UE based on the resolved health statuses of the plurality of candidate P-CSCFs.

According to another aspect of the present disclosure, a non-transitory computer-readable medium is provided. The non-transitory computer-readable medium stores instructions that, when executed by at least one processor of a first network node in a telecommunications network, cause the first network node to perform operations comprising: receiving a registration request at a first network node of the telecommunication network, the registration request including a request from a user equipment (UE) to establish an Internet Protocol (IP) Multimedia Subsystem (IMS) connection; for each P-CSCF of a plurality of candidate P-CSCFs, resolving a health status; and transmitting at least one P-CSCF IP address to the UE based on the resolved health statuses of the plurality of candidate P-CSCFs.

### BRIEF DESCRIPTION OF THE DRAWINGS

The following drawings are provided to help illustrate various features of examples of the disclosure and are not intended to limit the scope of the disclosure or exclude alternative implementations.

FIG. 1 illustrates an example of a telecommunications network in accordance with various aspects of the present disclosure.

FIG. 2 illustrates an example of a service-based architecture for a telecommunications network in accordance with various aspects of the present disclosure.

FIG. 3 illustrates an example of a messaging flow for a P-CSCF selection method according to a comparative example.

FIG. 4 illustrates an example of a messaging flow for a P-CSCF selection method in accordance with various aspects of the present disclosure.

FIG. 5 illustrates an example of a P-CSCF selection method in accordance with various aspects of the present disclosure.

FIG. 6 illustrates an example of a P-CSCF selection system in accordance with various aspects of the present disclosure.

### DETAILED DESCRIPTION

The disclosed technology is not limited in its application to the details of construction and the arrangement of components set forth in the following description or illustrated in the following drawings. Other examples of the disclosed technology are possible and examples described and/or illustrated here are capable of being practiced or of being carried out in various ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

A plurality of hardware and software-based devices, as well as a plurality of different structural components can be used to implement the disclosed technology. In addition, examples of the disclosed technology can include hardware, software, and electronic components or modules that, for purposes of discussion, can be illustrated and described as if the majority of the components were implemented solely in hardware. However, in at least one example, the electronic based aspects of the disclosed technology can be implemented in software (for example, stored on non-transitory computer-readable medium) executable by one or more electronic processors. Although certain drawings illustrate hardware and software located within particular devices, these depictions are for illustrative purposes only. In some examples, the illustrated components can be combined or divided into separate software, firmware, hardware, or combinations thereof. As one example, instead of being located within and performed by a single electronic processor, logic and processing can be distributed among multiple electronic processors. Regardless of how they are combined or divided, hardware and software components can be located on the same computing device or can be distributed among different computing devices connected by one or more networks or other suitable communication links.

The present disclosure is directed to wireless communications networks, also referred to herein as telecommunications networks. The systems and methods set forth herein may be implemented on a telecommunications network in compliance with any telecommunication standard or group of standards; for example, fourth-generation (4G) network standards such as Long Term Evolution (LTE) and/or fifth-generation (5G) network standards such as New Radio (NR). In an example implementation, the wireless communications networks described herein may represent a portion of a wireless network built around 5G standards promulgated by standards setting organizations under the umbrella of the Third Generation Partnership Project (“3GPP”). Accordingly, in some configurations, the wireless communication network may be a 5G network, such as, e.g., a 5G cellular network. Such 5G networks, including the wireless communication networks described herein, may comply with industry standards, such as, e.g., the Open Radio Access Network (Open RAN or O-RAN) standard that describes interactions between the network and user equipment (e.g., mobile phones and the like).

The O-RAN model follows a virtualized model for a cloud-native 5G wireless architecture in which 5G base stations, referred to as next-generation Node Bs (gNBs), are implemented using separate centralized units (CUs), distributed units (DUs), and radio units (RUS). In some configurations, O-RAN CUs and DUs may be implemented using software modules executed by distributed (e.g., cloud) computing hardware. Virtualization allows for various other components of the cellular network, such as cellular network core functions, to be implemented as code that is executed using general-purpose computing resources. Such general-purpose computing resources can be part of a public cloud-computing platform that provides virtual private clouds (VPCs) for multiple clients. On a hybrid cloud cellular network, RAN components of the cellular network are in communication with components of the cellular network executed on a public cloud computing platform, such as Amazon Web Services (AWS).

For voice communications, including Voice over LTE (VoLTE) using 5G networks, Voice over Wi-Fi (VoWi-Fi) using wireless internet networks, and Voice over NR (VoNR) using 5G networks, an Internet Protocol (IP) Multimedia Subsystem (IMS) framework may be provided. Collectively, these may referred to as Voice over IMS (VoIMS). By using VoIMS technologies, communications are routed via an IMS Core such that connections can be established and maintained between users of a first network and users of a second network, even if the second network is different from the first network, and even if the second network is based on a different architecture than the first network (e.g., between NR users and LTE users).

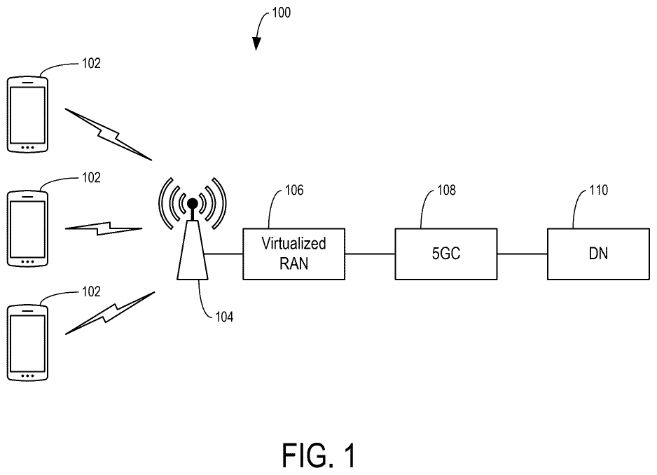

FIG. 1 illustrates an example of a telecommunications network 100 in accordance with various aspects of the present disclosure. In the telecommunications network 100 of FIG. 1, a plurality of UEs 102 are connected to a wireless access point 104, which in turn is connected to a set of virtualized RAN components 106. The virtualized RAN components 106 provide a connection to a 5G core network (5GC) 108, which in turn provides a connection to a data network 110. The wireless access point 104 and the virtualized RAN components 106 may collectively be referred to as a next-generation RAN (NG-RAN).

In some configurations, the telecommunications network 100 may be a standalone (SA) network (e.g., a 5G SA network) that utilizes 5G cells for both signaling and information transfer via a 5G packet core architecture. However, the present disclosure may be implemented with any type of telecommunication network capable of being virtualized.

As used herein, the term “UE” may be one of various types of end-user devices, such as cellular phones, smartphones, cellular modems, cellular-enabled computerized devices, sensor devices, robotic equipment, vehicles, IoT devices, gaming devices, access points (APs), or any computerized device capable of communicating via a cellular network. More generally, a UE 102 can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, a UE 102 may use RF to communicate with various base stations of a telecommunications network. While FIG. 1 illustrates three UEs 102 connected to the wireless access point 104, in practical implementations any number of UEs 102 may be connected to the wireless access point 104 at any given time.

The wireless access point 104 represents the physical infrastructure (e.g., a 5G tower) to which the UEs 102 connect. The wireless access point 104 may be any structure to which one or more antennas are mounted. The wireless access point 104 may be a dedicated cellular tower, a building, a water tower, or any other man-made or natural structure to which one or more antennas can reasonably be mounted to provide cellular coverage to a geographic area. The wireless access point 104 may include an RU configured to convert radio signals sent to and received from the antenna(s) into a digital signal. The wireless access point 104 is connected to the virtualized RAN components 106 via a fronthaul link over which the digital signals may be communicated. The virtualized RAN components 106 may include a DU connected to a CU via a midhaul link. The CU may be connected to the 5GC 108 via a backhaul link. While FIG. 1 illustrates a single wireless access point 104 and a single set of virtualized RAN components 106, in practical implementations the telecommunications network 100 may include any number of wireless access points 104 and/or any number of virtualized RAN components 106.

In one example, the telecommunications network 100 may be configured according to a region-based network topology. For example, the telecommunications network 100 may be implemented using a cloud computing platform that is logically and physically divided up into various different cloud computing regions (e.g., AWS regions). The cloud computing regions may be based on the geographical location of the gNBs; for example, the telecommunications network 100 for a given nation may be divided into a number of geographical regions. Each of the cloud computing regions can be isolated from other cloud computing regions to help provide fault tolerance, fail-over, load-balancing, and/or stability and each of the cloud computing regions can be composed of multiple availability zones or markets, each of which can be a separate data center located in general proximity to each other (e.g., within 100 miles). For example, one cloud computing region may have its datacenters and hardware located in the northeast of the United States while another cloud computing region may have its data centers and hardware located in California.

Each of the availability zones may be a discrete data center of a group of data centers that allows for redundancy, thereby to provide fail-over protection from other availability zones within the same cloud computing region. For example, if a particular data center of an availability zone experiences an outage, another data center of the availability zone or separate availability zone within the same cloud computing region can continue functioning and providing service. An availability zone may be divided into multiple local zones or areas-of-interest (AOIs). For instance, a client, such as a provider of the telecommunications network 100, can select from more options of the computing resources that can be reserved at an availability zone compared to a local zone. However, a local zone may provide computing resources nearby geographic locations where an availability zone is not available. Each local zone may be divided into multiple gNBs, each of which can serve one or more sites. A site may have one DU and a number of RUs (e.g., six RUs) assigned to it.

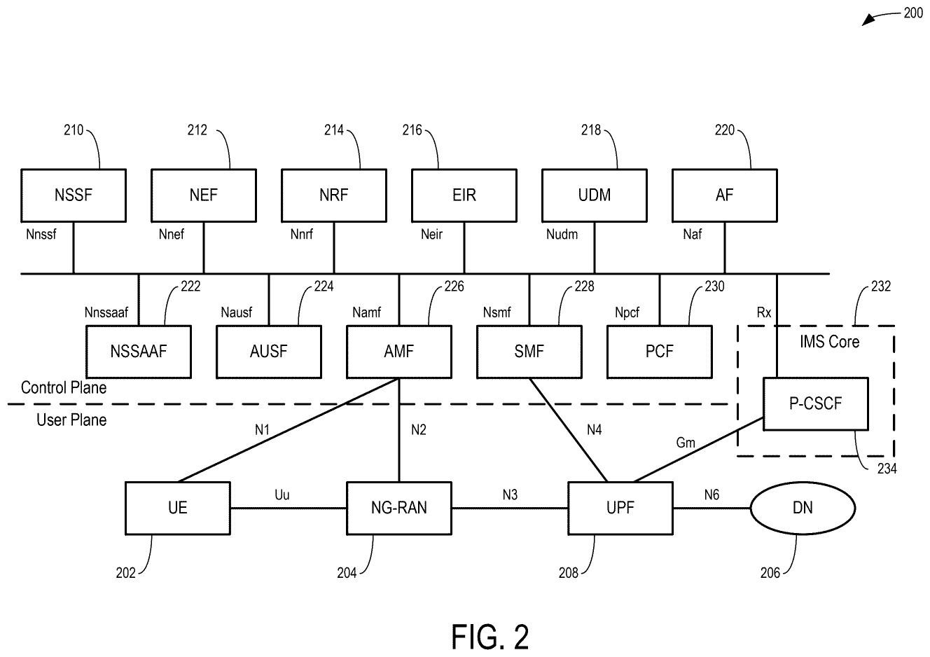

The 5GC 108 provides a plurality of 5G core functions. In the topology of a 5G NR cellular network, 5G core functions of 5GC 108 can logically reside as part of a national data center (NDC). An NDC can be understood as having its functionality existing in a cloud computing region across multiple availability zones. This arrangement allows for load-balancing, redundancy, and fail-over. In local zones, multiple regional data centers can be logically present. Each of regional data centers may execute 5G core functions for a different geographic region or group of RAN components. An example of 5G core components that can be executed within an RDC are described in more detail with regard to FIG. 2. The data network 110 may be the Internet, an enterprise data network, combinations thereof, and the like.

FIG. 2 illustrates an example service-based architecture (SBA) 200 for a telecommunications network (e.g., the telecommunications network 100 of FIG. 1) in accordance with various aspects of the present disclosure. The SBA 200 includes an infrastructure domain, which is divided between a control plane (CP) and a user plane (UP). The CP comprises a plurality of CP network functions (NFs). The UP comprises a UE 202 (e.g., one of the UEs 102 of FIG. 1) connected to an NG-RAN 204, and UP NFs. Using the SBA 200, the UE 202 accesses a data network 206 (e.g., the data network 110 of FIG. 1) and voice services via an IMS core 232. For case of illustration, FIG. 2 only shows a single UE 202 being connected to the NG-RAN 204; however, in practical implementations any number of UEs 202 may be present, limited only by the capacity of the network.

The UP NFs include a User Plane Function (UPF) 208. The UPF 208 is a network function that routes and forwards user plane data packets between the base station (cell site; for example, the NG-RAN 204) and the external data network 206 (e.g., the Internet), and routes and forwards voice packets between the base station and IMS core 232. The UPF 208 is similar to the service and packet gateway functions in a 4G network, but it is cloud-native and can be deployed anywhere to meet service requirements. It can also manage, prioritize, and duplicate data packets as they traverse the network, thus offering redundancy and quality-of-service (QoS) assurance.

The CP NFs include a Network Slice Selection Function (NSSF) 210, a Network Exposure Function (NEF) 212, a Network Repository Function (NRF) 214, an Equipment Identity Register (EIR) 216, a Unified Data Management (UDM) 218, an Application Function (AF) 220, a Network Slice-specific and SNPN Authentication and Authorization Function (NSSAAF) 222, an Authentication Server Function (AUSF) 224, an Access and Mobility Management Function (AMF) 226, a Session Management Function (SMF) 228, and a Policy Control Function (PCF) 230.

The NSSF 210 is a CP function that provides network slices to the AMF 226. A network slice is an independent, end-to-end logical network that runs on shared physical network infrastructure. It involves the allocation of network resources across all network infrastructure to meet specific service requirements, from the network core to the radio access network (RAN). Specific requirements may include QoS assurance, security policies, data isolation, dynamic policy management, etc.

The NEF 212 is a CP function that provides information regarding the network functions that are available to use (by the enterprise customer). It is similar to the 4G Service Capabilities Exposure Function (SCEF), but it is cloud-native and exposes event information, network monitoring, network control, provisioning capabilities, and policy/charging capabilities externally. This allows the enterprise customer to monitor and affect QoS and charging for devices.

The NRF 214 is a CP function that allows 5G network functions to be registered, discovered, and subsequently made available to customers. This is a unique capability in the standalone 5G network that allows customers to subscribe to the necessary microservices or to have dedicated network functions for their services.

The EIR 216 (sometimes referred to as a “5G-EIR”) is a CP function that provides the ability to check the status of a UE's identity, for example to determine whether the UE has been blacklisted from the network. The services provided by the EIR 216 are consumed by the AMF 226. It may be invoked during any procedure establishing a signaling connection between a UE and the network based on an equipment identifier of the UE.

The UDM 218 is a CP function that manages and stores subscriber and device information, default QoS and prioritization, authorized data channels, maximum bit rates, service continuity provisions, and the like. The UDM 218 is similar to the Home Subscriber Server (HSS) function in a 5G network, but it is cloud-native and designed for 5G services.

The AF 220 is a CP function that interacts with the 3GPP Core Network in order to provide services, for example to support one or more of application function influence on traffic routing, application function influence on service function chaining, accessing the NEF 212, interacting with the PCF 216, time synchronization service, IP multimedia subsystem (IMS) interactions with the 5GC, or packet data unit (PDU) set handling.

The NSSAAF 222 is a CP function that supports authentication and authorization of slicing with an AAA server (Authentication, Authorization, and Accounting). It is a unique capability of the standalone 5G network that allows customers to access a predefined network slice or a newly requested network slice in real-time and using their own existing authentication infrastructure.

The AUSF 224 is a CP function that supports authentication for 3GPP access and untrusted non-3GPP access, and authentication of a UE for a disaster roaming service. It can act as an authentication server.

The AMF 226 is a CP function that manages registration, authorization, connection, reachability, and mobility. It is similar to the Mobility Management Entity (MME) function in a 4G network, but it is cloud-native and supports many additional capabilities unique to 5G. For example, it also supports dynamic updating of network interfaces and cellular sites, greater privacy via the use of a 5G temporary device identity, enhanced security across the user and control planes, and stores network slice information. It can also select an appropriate PCF for a device or use case.

The SMF 228 is a CP function that oversees packet data session management, IP address allocation, data tunneling from a cell site base station to the user plane function, and downlink notification management. It performs the tasks of the serving and packet gateways (S-GW & P-GW) in a 4G network, but also allows for control plane and user plane separation in 5G.

The PCF 230 is a CP function that provides policies for mobility and session management. It is similar to the Policy and Charging Rules Function (PCRF) in a 4G network, but it is cloud-native and offers additional capabilities in the 5G network, including event-based policy triggers, resource reservation requests, and access network discovery and selection. The PCF 230 directly influences QoS and subscriber spending limits, and as a result plays a role in the enhanced policy management and control capabilities of the 5G network.

The IMS Core 232 provides for globally interoperable voice and communication services. IMS services are provided using a Proxy Call Session Control Function (P-CSCF) 234. The P-CSCF 234 provides a communication endpoint for services between the IMS Core 232 and the UE 202, through which the UE 202 can exchange messages. While FIG. 2 illustrates only a single P-CSCF 234, in practical implementations a number of different P-CSCFs 234 may be present, such as a primary P-CSCF, a secondary P-CSCF, a tertiary P-CSCF, and so on. The P-CSCF 234 may be integrated into an Access Session Border Controller (A-SBC).

The SBA 200 further includes a plurality of service-based interfaces to provide access to or communication with the various NFs. As illustrated, these include an Nnssf interface for the NSSF 210, an Nnef interface for the NEF 212, an Nnrf interface for the NRF 214, an Neir for the EIR 216, an Nudm interface for the UDM 218, an Naf interface for the AF 220, an Nnssaaf interface for the NSSAAF 222, an Nausf interface for the AUSF 224, an Namf interface for the AMF 226, an Nsmf interface for the SMF 228, an Npcf interface for the PCF 230. FIG. 1 also illustrates several reference points (i.e., interfaces between two NFs or entities), including an N1 interface between the UE 202 and the AMF 226, a Uu interface between the UE 202 and the NG-RAN 204, an N2 interface between the NG-RAN 204 and the AMF 226, an N3 interface between the NG-RAN 204 and the UPF 208, an N4 interface between the UPF 208 and the SMF 228, and an N6 interface between the UPF 208 and the data network 206. Any of the above-described interfaces may be an SBI interface (e.g., an http2 based interface). FIG. 2 further illustrates an Rx interface between the IMS Core 232 (e.g., the P-CSCF 234) and the 5GC, and a Gm interface between the UPF 208 and the IMS Core 232 (e.g., the P-CSCF 234). The Rx interface and/or the Gm interface may be Diameter interfaces.

The above-listed NFs and interfaces are intended to be illustrative and not exhaustive. In practical implementations, the SBA 200 may include additional NFs or other network entities, such as an Unstructured Data Storage Function (UDSF), a Network Slice Admission Control Function (NSCAF), a Unified Data Repository (UDR), a UE radio Capability Management Function (UCMF), a Charging Function (CHF), a Time Sensitive Networking AF (TSN AF), a Time Sensitive Communication and Time Synchronization Function (TSCTSF), a Data Collection Coordination Function (DCCF), an Analytics Data Repository Function (ADRF), a Messaging Framework Adaptor Function (MFAF), a Non-Seamless WLAN Offload Function (NSWOF), an Edge Application Server Discovery Function (EASDF), a Service Communication Proxy (SCP), a Security Edge Protection Proxy (SEPP), a Non-3GPP InterWorking Function (N3IWF), a Trusted Non-3GPP Gateway Function (TNGF), a Wireline Access Gateway Function (W-AGF), a Network Data Analytics Function (NWDAF), or a Trusted WLAN Interworking Function (TWIF).

Any of the NFs illustrated in FIG. 2 and/or described above may be implemented as a software unit residing on a server (i.e., in the cloud). Each NF can include multiple pods. A “pod” refers to a software sub-component of the NF. Kubernetes, Docker, or some other container orchestration platform can be used to create and destroy the logical CU or 5G core units and subunits as needed for the data network 110 to function properly. The pods may be deployed on one or more virtual machines configured by a network operator. Kubernetes allows for container deployment, scaling, and management. As an example, if cellular traffic increases substantially in a region, an additional logical CU or components of a CU may be deployed in a data center near where the traffic is occurring without any new hardware being deployed. Instead, processing and storage capabilities of the data center would be devoted to the needed functions. When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers. Thus, the SBA 200 may be implemented on or using one or more computing devices, each of which includes a processor and a memory.

As used herein, a “processor” may include one or more individual electronic processors, each of which may include one or more processing cores, and/or one or more programmable hardware elements. The processor may be or include any type of electronic processing device, including but not limited to central processing units (CPUs), graphics processing units (GPUs), application-specific integrated circuits (ASICs), field-programmable gate arrays (FPGAs), microcontrollers, digital signal processors (DSPs), or other devices capable of executing software instructions. When a device is referred to as “including a processor,” one or all of the individual electronic processors may be external to the device (e.g., to implement cloud or distributed computing). In implementations where a device has multiple processors and/or multiple processing cores, individual operations described herein may be performed by any one or more of the microprocessors or processing cores, in series or parallel, in any combination. In some implementations, one or more of the processing units or processing cores may be remote (e.g., cloud-based).

As used herein, a “memory” may be any storage medium, including a non-volatile medium, e.g., a magnetic media or hard disk, optical storage, or flash memory; a volatile medium, such as system memory, e.g., random access memory (RAM) such as dynamic RAM (DRAM), synchronous dynamic RAM (SDRAM), static RAM (SRAM), extended data out (EDO) DRAM, extreme data rate dynamic (XDR) RAM, double data rate (DDR) SDRAM, etc.; on-chip memory; and/or an installation medium where appropriate, such as software media, e.g., a CD-ROM, or floppy disks, on which programs may be stored and/or data communications may be buffered. The term “memory” may also include other types of memory or combinations thereof. For the avoidance of doubt, cloud storage is contemplated in the definition of memory. A memory is an example of a non-transitory computer-readable medium which stores instructions that are executable by a processor (or processors), the execution of which causes the executing device (e.g., a computer) to perform certain operations, such as those operations described herein.

In the SBA 200 shown in FIG. 2, the NG-RAN 204 may include some or all of the virtualized RAN components 106 illustrated in FIG. 1. Thus, the NG-RAN 204 may include at least one CU, at least one DU configured to operate under the control of one or more of the at least one CU, and at least one RU configured to operate under the control of one or more of the at least one DU. For example, each CU in the NG-RAN 204 may control a plurality of DUs, each of which in turn may control a plurality of RUs. Each RU may be operatively connected to a power amplifier and transmission elements (e.g., antennae) configured to cooperate to transmit signals to connected UEs 202 according to a transmission schedule.

In examples, the SBA 200 may be applicable to a particular cloud computing region. For example, as noted above, one instance of the SBA 200 may exist within a first geographical region (e.g., the northeastern United States) while another instance of the SBA 200 may exist within a second geographical region (e.g., the western United States). In this implementation, the above described NFs may be embodied in the form of computing nodes in data centers located within the corresponding geographical region. Thus, the first instance of the SBA 200 may be implemented by computing nodes in one or more data centers physically located in the northeastern United States, the second instance of the SBA 200 may be implemented by computing nodes in one or more data centers physically located in the western United States, and so on. Within each instance of the SBA 200, the computing nodes may be configured to implement at least instance of each of the above-described NFs.

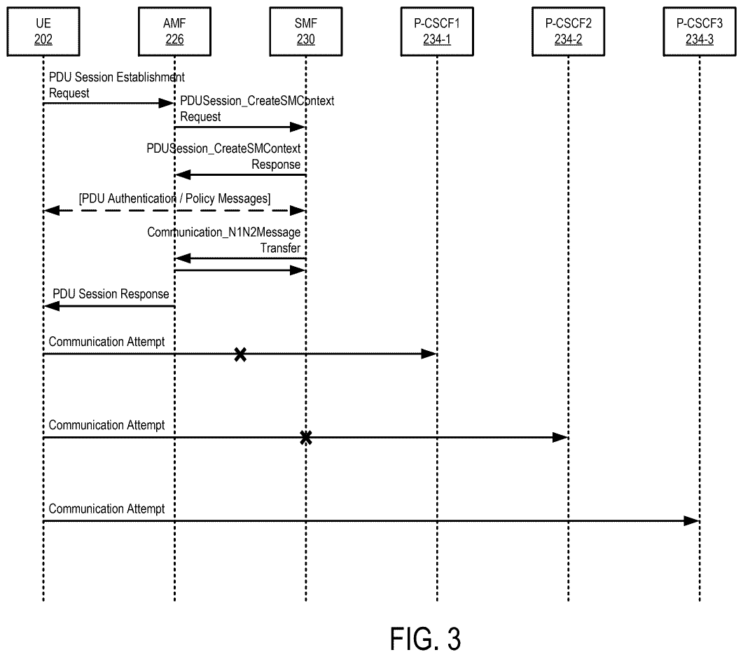

The NFs operate together to perform and/or manage various procedures within the network, including connection, registration, and mobility management procedures. For example, in order to receive services from the network, a UE must first register with the network (e.g., when initially joining the network, when moving to a new tracking area within the network, and so on). When the UE seeks to register with the network, a series of operations are performed, including the transmission of messages between the various network entities (e.g., between various NFs) of the SBA 200. These operations include an NR attach procedure and PDU session establishment procedures. FIG. 3 illustrates an example of the message flow for a portion of the overall registration procedure according to a comparative example.

In FIG. 3, the UE 202, the AMF 226, the SMF 230, and three candidate P-CSCFs 234-1, 234-2, and 234-3 (collectively referred to as a P-CSCF 234 when it is not necessary to identify a single candidate) are shown for case of explanation, although it should be noted that additional NFs (e.g., the UDM 218, the AUSF 224, etc.) may be implicated in registration operations not illustrated in FIG. 3, such as registration operations that occur prior to or subsequent to those illustrated in FIG. 3. Additionally, while FIG. 3 illustrates three candidate P-CSCFs 234-1-234-3, in practice any number of candidate P-CSCFs may be present. The operations illustrated in FIG. 3 are part of the PDU session establishment procedure. During the registration procedure, these operations may occur after the UE 202 sends a registration request to the AMF 226 and authentication and/or security operations are performed.

The PDU session establishment procedure begins with the UE 202 sending a PDU Session Establishment Request to the AMF 226. The PDU Session Establishment Request includes a PDU Session ID an indicator that the UE 202 requests a P-CSCF IP address. The AMF 226 in turn sends a PDUSession_CreateSMContext Request (or, if another PDU session already exists for the PU Session ID, a PDUSession_UpdateSMContext Request) to the SMF 230 via the Nsmf interface. At this point, additional messages may be exchanged among the various NFs, including messages for PDU session authentication/authorization and for policy association establishment or modification.

The SMF 230 determines the IP address of the P-CSCF 234 to which the UE 202 should be assigned for IMS services, including VoNR. The IP address of the P-CSCF 234 may be locally configured in the SMF 230, or may be discovered by the SMF 230. In the comparative example of local configuration, the SMF 230 includes IP addresses corresponding to the candidate P-CSCFs 234, and selects the P-CSCF 234 using a round-robin method. In the comparative example of discovered configuration, the SMF 230 may query the NRF 214 which responds with the IP address or the Fully Qualified Domain Name (FQDN) of the available candidate P-CSCFs 234. The SMF 230 selects the P-CSCFs 234 from among the resolved candidates and, if the address was received in the form of an FQDN, resolves it to an IP address. In this comparative example, the SMF 230 selects a P-CSCF 234 from the resolved addresses using either a round-robin or randomized selection method. The SMF 230 then sends the IP address of a number (e.g., three) selected P-CSCFs 234 to the UE 202 in the PDU Session Response portion of a Communication_N1N2Message Transfer via the AMF 226, which transparently forwards the IP address of the selected P-CSCFs 234.

However, because the SMF 230 selects the P-CSCFs 234 using a round-robin or randomized selection method in the comparative example, the selection is made without consideration of the health (relative or absolute) of the candidate P-CSCFs 234. Thus, the SMF 230 may select a P-CSCF 234 that is malfunctioning or poorly functioning, and thus cause voice service interruption or other communication errors when the UE 202 attempts to utilize IMS services via the selected P-CSCF 234. FIG. 3 illustrates an example situation where the SMF 230 selects P-CSCF 234-1 as a primary P-CSCF, P-CSCF 234-2 as a secondary P-CSCF, and P-CSCF 234-3 as a tertiary P-CSCF, but where the first and second P-CSCFs 234-1 and 234-2 are malfunctioning or poorly functioning. In this case, the UE 202 attempts communication (e.g., a VoNR call) via the P-CSCF 234-1, but the communication fails. Thus (and possibly after a time-out period has elapsed), the UE 202 attempts the communication via the P-CSCF 234-2. However, this communication also fails. Finally, the UE 202 attempts the communication via the P-CSCF 234-3, and only then is able to perform the communication.

To overcome this and other deficiencies in the comparative example, the present disclosure provides systems and methods by which the SMF 230 may dynamically select one or more healthy P-CSCFs 234, for example if one or more of the P-CSCFs 234 is experiencing issues. In an example, the selection and health determination may be based on a response received from a DNS server, for example in an AWS/public cloud. Thus, the present disclosure provides systems and methods that reduce instances of voice service interruption and add global level redundancy in the AWS/public cloud environment. A P-CSCF 234 may be considered healthy if it is capable of responding to request messages (e.g., by issuing a 200 OK message). In some implementations, a P-CSCF 234 may be considered healthy if it has a sufficient amount of processing and/or memory resources (e.g., greater than a threshold amount).

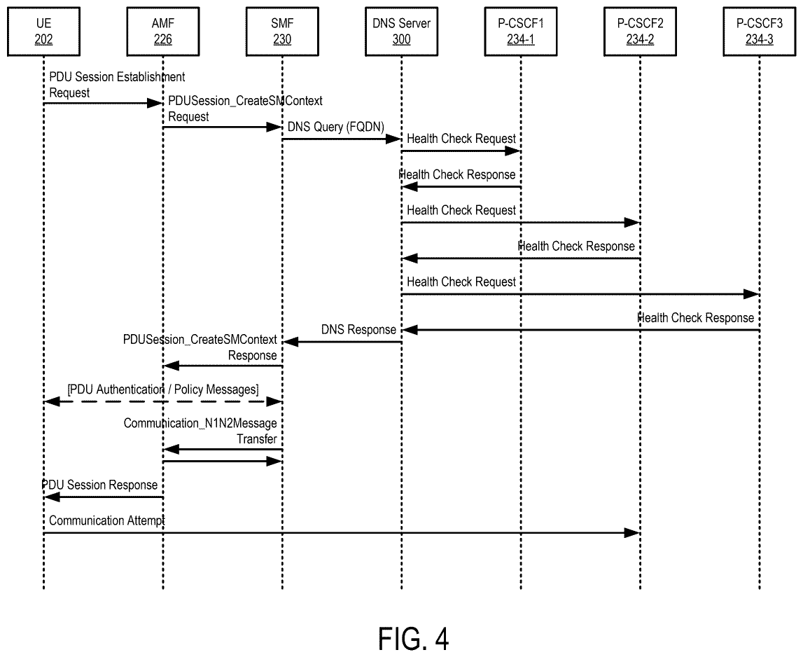

FIG. 4 illustrates an example message flow for a portion of the overall registration procedure according to the present disclosure. In FIG. 4, the UE 202, the AMF 226, the SMF 230, a DNS server 300, and three candidate P-CSCFs 234-1, 234-2, and 234-3 (collectively referred to as a P-CSCF 234 when it is not necessary to identify a single candidate) are shown for ease of explanation, although it should be noted that additional NFs (e.g., the UDM 218, the AUSF 224, etc.) may be implicated in registration operations not illustrated in FIG. 4, such as registration operations that occur prior to or subsequent to those illustrated in FIG. 4. Additionally, while FIG. 4 illustrates three candidate P-CSCFs 234-1-234-3, in practice any number of candidate P-CSCFs may be present. The operations illustrated in FIG. 4 are part of the PDU session establishment procedure. During the registration procedure, these operations may occur after the UE 202 sends a registration request to the AMF 226 and authentication and/or security operations are performed.

As in the comparative example, the PDU session establishment procedure begins with the UE 202 sending a PDU Session Establishment Request to the AMF 226. The PDU Session Establishment Request includes a PDU Session ID an indicator that the UE 202 requests a P-CSCF IP address. The AMF 226 in turn sends a PDUSession_CreateSMContext Request (or, if another PDU session already exists for the PU Session ID, a PDUSession_UpdateSMContext Request) to the SMF 230 via the Nsmf interface. The SMF 230 determines the IP address of the P-CSCF 234 to which the UE 202 should be assigned for IMS services, including VoNR. Unlike in the comparative example, however, the SMF 230 queries the DNS server 300 (e.g., with a FQDN). The DNS server 300 initiates a health check by sending a Health Check Request message to each available candidate P-CSCF 234. Each candidate P-CSCF 234 sends a Health Check Response message, which includes an indicator of P-CSCF health, back to the DNS server 300. While FIG. 4 illustrates the Health Check Requests being sent in series, in practice a Health Check Request may be sent to each candidate P-CSCF 234 simultaneously or substantially simultaneously, without waiting for any responses. Based on the relative health of the available P-CSCFs 234, the DNS server 300 transmits a DNS Response to the SMF 230. The DNS Response includes a list of target P-CSCFs 234 based on the health indicators. For example, if it is determined that P-CSCF 234-2 is healthiest, P-CSCF 234-1 is moderately healthy, and P-CSCF 234-3 is not healthy (or that the P-CSCFs 234-1 and 234-2 and the P-CSCF 234-3 is not healthy), the DNS Response may include the P-CSCF 234-2 as primary P-CSCF and the P-CSCF 234-2 as secondary P-CSCF. The response may include IP addresses corresponding to the primary and any lower-priority P-CSCFs 234.

At this point, additional message may be exchanged among the various NFS, including messages for PDU session authentication/authorization and for policy association establishment or modification. In any event, after the SMF 230 has determined the IP address(es) of the health P-CSCFs 234, the SMF 230 then communicates the IP address(es) to the UE 202 via the AMF 226. Later, when the UE 202 attempts to perform a VoNR communication, it communicates with the primary P-CSCF (here, P-CSCF 234-2) and is not at risk of (or is at a reduced risk of) voice service interruption.

While FIG. 4 illustrates the health check operations taking place in response to the DNS Query received at the DNS server 300 from the SMF 230, in other implementations the DNS server 300 may perform the health check at predetermined intervals. In such implementations, the DNS server 300 may store information regarding the relative health of the P-CSCFs 234. Thus, the DNS server 300 may be capable of immediately responding to the DNS Query with a DNS Response. Additionally, while FIG. 4 illustrates the health check operations taking place immediately after the PDUSession_CreateSMContext Request message is received by the SMF 230, in other implementations the health check operations (including the DNS Query and Response messages) may be performed at a later time, as long as such time comes before the AMF 226 and/or the SMF 230 informs the UE 202 of the P-CSCF IP address(es). Moreover, while the above description presents one example of a message flow occurring as part of an initial registration procedure, the operations of FIG. 4 may instead or additionally be formed for a UE 202 that is already connected to the network. For example, if an already-registered UE 202 initializes a VoIMS call and receives an error, the DNS Query, Health Check Request/Response, and DNS Response operations may be performed to obtain a new P-CSCF 234.

It should be noted that FIG. 4 illustrates an example of message flow occurring in a 5G NR network. If the message flow is instead occurring in a 4G LTE network (e.g., for a VoLTE communication), the PDU session establishment procedure may be instead mediated by a Packet Gateway (PGW) instead of the SMF 230.

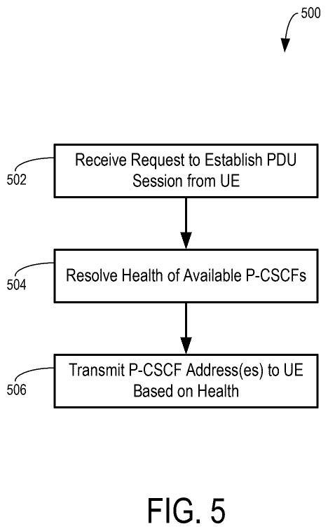

FIG. 5 illustrates an example method 500 of performing P-CSCF selection. In an example, the method 500 may be performed by a network node corresponding to the SMF 230 (or, if the network is an LTE network, by the PGW). In other examples, the method 500 is performed under the control of the network node corresponding to the SMF 230, such that while some of the operations of the method 500 are performed by the network node corresponding to the SMF 230 itself, other operations of the method 500 are performed by other network nodes (e.g., corresponding to other NFs) under the direction of the SMF 230. Any of the above-described network nodes may, separately or in combination, be a implemented as cloud computing node located at a data center associated with a cloud computing region of a network in accordance with the present disclosure.

The message begins with operation 502 of receiving a registration request at the network node. The registration request may be or include a request to establish an IMS connection (e.g., a VoNR or VoLTE connection), and may be received from a UE (e.g., via an AMF). In an example, the registration request may correspond to the PDU Session Establishment Request illustrated in FIG. 4. At operation 504, the network node resolves a health status for a plurality of available P-CSCFs. Operation 504 may include transmitting a DNS query from the SMF network node to a DNS server. In examples, the DNS query may correspond to the DNS Query message illustrated in FIG. 4. Operation 504 may be based on a run-time health check, as illustrated in FIG. 4, or based on a pre-performed health check, such as one regularly performed in the network.

In the example of the run-time health check, operation 504 may include operations performed in response to the registration request (e.g., operations performed by the DNS server upon receipt of the DNS query). For example, operation 504 may include, for each P-CSCF of the available candidate P-CSCFs, transmitting a health check request from the DNS server to the corresponding P-CSCF. These messages may correspond to the Health Check Request messages illustrated in FIG. 4. The P-CSCFs may respond with a health check response that includes a health indicator, which is received by the DNS server. These messages may correspond to the Health Check Response messages illustrated in FIG. 4. Upon receipt of the health check responses, or after a time-out period has elapsed (e.g., to account for P-CSCFs that are malfunctioning and do not send a response), the DNS server resolves the health status of the P-CSCFs based on the received health indicators. Alternatively, the DNS server may transmit the health indicators to the network node in a DNS response (e.g., the DNS Response message illustrated in FIG. 4) such that the network node itself resolves the health status.

In the example of a pre-performed health check, the DNS sever may be configured to transmit health check request messages to available P-CSCFs at predetermined intervals. The predetermined intervals may be fixed or changing. The health check request messages may resemble those illustrated in FIG. 4 and described above, but transmitted earlier than the message flow illustrated in FIG. 4. The P-CSCFs may respond with a health check response that includes a health indicator, which is received by the DNS server. These messages may resemble the Health Check Response messages illustrated in FIG. 4, but received earlier than the message flow illustrated in FIG. 4. The DNS server may then store the health indicators in a memory thereof. Then, in response to the receipt of the DNS query from the network node, the DNS server may resolve the health status of the P-CSCFs based on the stored health indicators. Alternatively, the DNS server may transmit the health indicators to the network node in a DNS response to the DNS query (e.g., as illustrated in FIG. 4) such that the network node itself resolves the health status.

In either case, once the health statuses have been resolved, at operation 506 the network node transmits at least one P-CSCF IP address to the UE based on the resolved health statuses of the plurality of candidate P-CSCFs. This operation may include, for example, determining a primary P-CSCF and a secondary P-CSCF based on the resolved health statuses (e.g., by selecting the two healthiest P-CSCFs), and transmitting the primary P-CSCF and second P-CSCF IP addresses to the UE (e.g., via the AMF). In other examples, a tertiary P-CSCF, quaternary P-CSCF, and/or higher order P-CSCFs may further be selected; alternatively only a primary P-CSCF may be selected. The network node (and/or the DNS server) may be configured to receive a FQDN and resolve the FQDN into an IP address for each P-CSCF.

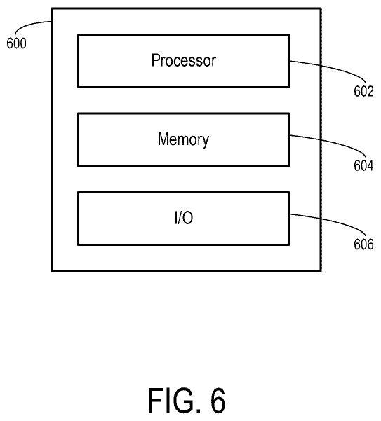

FIG. 6 illustrates one example of a dynamic P-CSCF selection node 600, which is itself an example of a computing node configured to implement the method 500 described above. As illustrated, the dynamic P-CSCF selection management node 600 comprises a processor 602, a memory 604, and an input/output (I/O) interface 606. The dynamic P-CSCF selection node 600 may be configured with various modules (e.g., various software modules) to implement identity check functions. In some implementations, the dynamic P-CSCF selection node 600 may correspond to one of the above described network nodes (e.g., a network node associated with one or more NFs). In one example, the dynamic P-CSCF selection node 600 is associated with an SMF of the network. In another example, the dynamic P-CSCF selection node 600 is associated with a DNS server of the network.

In one example, the modules may be present in the memory 604 in the form of instructions that, when executed by the processor 602, cause the dynamic P-CSCF selection node 600 to perform any one or more of the operations described herein. In another example, the processor 602 may be configured to load and/or execute instructions from another non-transitory computer-readable medium (e.g., cloud storage or from the memory of another device). In some examples, the following modules may be in the form of xApps and/or rApps (or portions or combinations thereof).

The dynamic P-CSCF selection node 600 may comprise a logic module configured to perform various determinations and other logical operations. In the example in which the dynamic P-CSCF selection node 600 is associated with the SMF, the logic module may be configured to generate and/or execute instructions to receive a registration request (e.g., via the I/O interface 606), instructions to transmit a DNS query to another network node (e.g., via the I/O interface 606), instructions to receive a DNS response (e.g., via the I/O interface 606), instructions to resolve a health status (e.g., based on health indicators received via the I/O interface 606), instructions to resolve an IP address (e.g., based on a FQDN), instructions to transmit one or more P-CSCF IP addresses (e.g., via the I/O interface 606), and the like.

The I/O interface 606 may include interface components to permit the communication of data to and from external devices or sources. For example, the I/O interface 606 may include communication ports and/or interfaces to permit communication with other computer devices. The communication ports and/or interfaces may permit input and output via wired protocols (e.g., Ethernet, Universal Serial Bus (USB), FireWire, etc.) and/or wireless protocols (e.g., Wi-Fi, Bluetooth, Near Field Communication (NFC), 5G, 4G, etc.). The I/O interface 606 may additionally or alternatively include communication ports and/or interfaces to permit communication with a user. For example, the I/O interface 606 may include interfaces for a mouse, a keyboard, a display, a graphical user interface (GUI), buttons, switches, etc.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method of performing proxy call session control function (P-CSCF) selection in a telecommunications network, the method comprising:
receiving a registration request at a first network node of the telecommunication network, the registration request including a request from a user equipment (UE) to establish an Internet Protocol (IP) Multimedia Subsystem (IMS) connection;
for each P-CSCF of a plurality of candidate P-CSCFs, resolving a health status; and
transmitting at least one P-CSCF IP address to the UE based on the resolved health statuses of the plurality of candidate P-CSCFs.

2. The method of claim 1, wherein resolving the health status includes:
in response to the registration request:
transmitting, from the first network node to a domain name system (DNS) server of the telecommunications network, a DNS query,
transmitting, from the DNS server to the respective P-CSCF, a health check request,
receiving, at the DNS server from the respective P-CSCF, a health check response including a health indicator, and
resolving the health status of the respective P-CSCF based on the health indicator.

3. The method of claim 1, wherein resolving the health status includes:
transmitting, from the first network node to a domain name system (DNS) server of the telecommunications network, a DNS query;
at predetermined intervals:
transmitting, from the DNS server to the respective P-CSCF, a health check request,
receiving, at the DNS server from the respective P-CSCF, a health check response including a health indicator, and
storing the health indicator in a memory of the DNS server; and
in response to the registration request, resolving the health status of the respective P-CSCF based on the stored health indicator.

4. The method of claim 1, wherein transmitting the at least one P-CSCF IP address includes:
based on the resolved health status, determining a primary P-CSCF and a secondary P-CSCF of the plurality of candidate P-CSCFs; and
transmitting a primary P-CSCF IP address and a secondary P-CSCF IP address to the UE.

5. The method of claim 1, further comprising:
receiving a fully qualified domain name (FQDN); and
resolving the at least one P-CSCF IP address based on the FQDN.

6. The method of claim 1, wherein the IMS connection is a Voice over New Radio (VoNR) or Voice over Long-Term Evolution (VoLTE) connection.

7. The method of claim 1, wherein the first network node is associated with a Session Management Function (SMF) of the telecommunications network.

8. A telecommunications network comprising:
at least one first processor in communication with a first network node of the telecommunications network; and
a first memory storing first instructions that, when executed by the at least one first processor, cause the first network node to:
receive a registration request at a first network node of the telecommunication network, the registration request including a request from a user equipment (UE) to establish an Internet Protocol (IP) Multimedia Subsystem (IMS) connection,
for each P-CSCF of a plurality of candidate P-CSCFs, resolve a health status, and
transmit at least one P-CSCF IP address to the UE based on the resolved health statuses of the plurality of candidate P-CSCFs.

9. The network of claim 8, further comprising:
at least one second processor in communication with a second network node of the telecommunications network; and
a second memory storing second instructions executable by the at least one second processor,
wherein the first instructions, when executed by the at least one first processor, further cause the first network node to, in response to the registration request:
transmit, to the second network node, a DNS query, and
wherein the second instructions, when executed by the at least one second processor, cause the second network node to:
transmit, to the respective P-CSCF, a health check request, and
receive, from the respective P-CSCF, a health check response including a health indicator.

10. The network of claim 8, further comprising:
at least one second processor in communication with a second network node of the telecommunications network; and
a second memory storing second instructions executable by the at least one second processor,
wherein the first instructions, when executed by the at least one first processor, further cause the first network node to, in response to the registration request:
transmit, to the second network node, a DNS query, and
wherein the second instructions, when executed by the at least one second processor, cause the second network node to, at predetermined intervals:
transmit, to the respective P-CSCF, a health check request,
receive, from the respective P-CSCF, a health check response including a health indicator, and
store the health indicator in the second memory.

11. The network of claim 8, wherein transmitting the at least one P-CSCF IP address includes:
based on the resolved health status, determining a primary P-CSCF and a secondary P-CSCF of the plurality of candidate P-CSCFs; and
transmitting a primary P-CSCF IP address and a secondary P-CSCF IP address to the UE.

12. The network of claim 8, wherein the first instructions, when executed by the at least one first processor, further cause the first network node to:
receive a fully qualified domain name (FQDN); and
resolve the at least one P-CSCF IP address based on the FQDN.

13. The network of claim 8, wherein the IMS connection is a Voice over New Radio (VoNR) or Voice over Long-Term Evolution (VoLTE) connection.

14. The network of claim 8, wherein the first network node is associated with a Session Management Function (SMF) of the telecommunications network.

15. A non-transitory computer-readable medium storing instructions that, when executed by at least one processor of a first network node in a telecommunications network, cause the first network node to perform operations comprising:
receiving a registration request at a first network node of the telecommunication network, the registration request including a request from a user equipment (UE) to establish an Internet Protocol (IP) Multimedia Subsystem (IMS) connection;
for each P-CSCF of a plurality of candidate P-CSCFs, resolving a health status; and
transmitting at least one P-CSCF IP address to the UE based on the resolved health statuses of the plurality of candidate P-CSCFs.

16. The non-transitory computer-readable medium of claim 15, wherein resolving the health status includes:
in response to the registration request:
transmitting, from the first network node to a domain name system (DNS) server of the telecommunications network, a DNS query,
causing the DNS server to transmit, to the respective P-CSCF, a health check request,
causing the DNS server to receive, from the respective P-CSCF, a health check response including a health indicator, and
resolving the health status of the respective P-CSCF based on the health indicator.

17. The non-transitory computer-readable medium of claim 15, wherein resolving the health status includes:
transmitting, from the first network node to a domain name system (DNS) server of the telecommunications network, a DNS query;
at predetermined intervals:
causing the DNS server to transmit, to the respective P-CSCF, a health check request,
causing the DNS server to receive, from the respective P-CSCF, a health check response including a health indicator, and
causing the DNS server to store the health indicator in a memory of the DNS server; and
in response to the registration request, resolving the health status of the respective P-CSCF based on the stored health indicator.

18. The non-transitory computer-readable medium of claim 15, wherein transmitting the at least one P-CSCF IP address includes:
based on the resolved health status, determining a primary P-CSCF and a secondary P-CSCF of the plurality of candidate P-CSCFs; and
transmitting a primary P-CSCF IP address and a secondary P-CSCF IP address to the UE.

19. The non-transitory computer-readable medium of claim 15, the operations further comprising:
receiving a fully qualified domain name (FQDN); and
resolving the at least one P-CSCF IP address based on the FQDN.

20. The non-transitory computer-readable medium of claim 15, wherein the first network node is associated with a Session Management Function (SMF) of the telecommunications network.
